(19) United States
(12) Patent Application Publication
(10) Pub. No.: US 2003/0057384 A1
(43) Pub. Date: Mar. 27, 2003

(54) Method of detecting flaw and apparatus for detecting flaw

(75) Inventor: Kazuhiko Fukazawa, Misato-shi (JP)

Correspondence Address: OLIFF & BERRIDGE, PLC, P.O. BOX 19928, ALEXANDRIA, VA, 22320, US

(73) Assignee: Nikon Corporation

(21) Appl. No.: 10/270,581

(22) Filed: Oct. 16, 2002

Related U.S. Application Data
(63) Continuation of application No. 09/626,922, filed on Jul. 27, 2000.

(30) Foreign Application Priority Data
Jul. 29, 1999 (JP) JP A 11-215985

(51) Int. Cl. G01N 21/88

(52) U.S. Cl. 250/559.45

(57) ABSTRACT

A silicon wafer formed with a circuit pattern is illuminated with light. Illuminating light diffracted by the silicon wafer is picked up by a CCD camera. An angle of incidence θi of the illuminating light and an angle of diffraction θd of the diffracted light is taken as a single set, parameters of the single set are changed at least once and a diffracted pattern from the silicon wafer is imaged two times. The parameters of the single set are decided so as to fulfill P×(sinθd−sinθi)=mλ, where P is the pitch of the pattern, λ is the wavelength of the illuminating light, and m is the diffraction order of the diffracted light. An image processing device then traces the larger of level signals for image signals obtained from the double-imaging to obtain an inspection signal. This makes changes in signal waveforms for flaws conspicuous.

### INCORPORATION BY REFERENCE

The disclosure of the following priority application is incorporated herein by reference:

Japanese Patent Application No. 11-215985 filed Jul. 29, 1999.

### BACKGROUND OF THE INVENTION

1. Field of the Invention

The present invention relates to a flaw detecting method and apparatus for detecting flaws in patterns continuously formed on a IC wafer made of silicon or a liquid crystal substrate made from glass.

2. Description of the Related Art

A circuit pattern is formed on a semiconductor wafer or liquid crystal substrate (hereinafter referred to as “substrate”) through a photolithographic process. In the optical lithographic process, a resist is applied to a surface of the substrate and a circuit pattern image is projected onto this resist via a mask. A latent image of a circuit pattern is formed on the resist and a circuit pattern is formed on the substrate by etching. Inspection for the presence of flaws in the circuit pattern formed in this manner is then required in a substrate manufacturing process.

In conventional flaw detection, an inspector illuminates the substrate surface with an illuminating system and looks at the substrate directly for blemishes and dirt etc. while rotating the substrate and tilting the substrate in order to change the illumination angle. This visual inspection by an inspector is, however, unreliable due to individual differences and is inefficient.

Recently, automatic flaw inspection apparatus are disclosed in, for example, Japanese Patent Publication No. Hei. 6-8789. With this inspection apparatus, a semiconductor wafer is illuminated with light for inspection and reflected and diffracted light from the semiconductor wafer is picked up by a detector such as an image-sensing element. The detector converts the image reflected from the wafer into an electrical signal and the converted image signal is captured by an image processing apparatus. The image processing apparatus then detects flaws in the semiconductor wafer based on the captured image signal.

However, with detection apparatus that receive diffracted light using a detector and then output an image signal, image unevenness and lowering of the image signal occurs due to changes in the height of a continuous pattern (changes in height due to unevenness of the resist) or changes in the height of a foundation layer. As a result, there may be a risk of detection errors. Further, if the pitch width of an accurately defined repeating pattern deviates slightly from the design value, the image signal deteriorates and detection errors may occur.

For example, a pattern is formed on a resist R with an equal interval pitch P on a silicon wafer W, as shown in FIG. 6(a). When there are no flaws with regards to the thickness of the resist R and the substrate which are in good condition, the amount of light outputted for the diffracted image is fixed, as shown in FIG. 6(b).

When the thickness of the resist R and the substrate are acceptable but a flaw is present, as shown in FIG. 7(a), the amount of light outputted for the diffracted image falls at the flaw, as shown in FIG. 7(b).

When there are no flaws but the thickness of the resist R changes, as shown in FIG. 8 (a), the amount of light outputted for the diffracted image at the portion where the thickness of the resist R is different changes, as shown in FIG. 8(b).

While, when the thickness of the resist R changes and there is also a flaw D, as shown in FIG. 9(a), the amount of light outputted for the diffracted image at the flaw D falls, as shown in FIG. 9(b). However, the overall amount of light outputted for the portion where the thickness of the resist R is different also changes and it therefore becomes difficult to detect relative differences in the amount of light received for the flaw D and for other portions.

### SUMMARY OF THE INVENTION

It is therefore the object of the present invention to provide a flaw detection method and apparatus for detecting flaws in a pattern in a nonerroneous manner regardless of changes in resist thickness and/or substrate layer thickness.

The present invention achieves the aforementioned object with a method for detecting flaws in a pattern formed on a substrate, comprising the steps of irradiating the substrate with illuminating light; receiving light of the illuminating light diffracted from the substrate; setting different inspection conditions, for one set of at least two parameters of wavelength of the illuminating light, angle of incidence of the illuminating light, angle of diffraction of the diffracted light and diffraction order of the diffracted light, a plurality of times; and detecting the flaws based on a plurality of pattern images due to the diffracted light obtained according to the plurality of inspection conditions set in the setting step.

In the process for detecting flaws, at least two of the parameters θi , θd, m or λ can be changed in order that the equation:

P×(sinθd−sinθi)=mλ

is satisfied for a pattern of pitch P, illuminating light of wavelength λ, an angle of incidence of the illuminating light of θi, an angle of diffraction of the diffracted light of θd, and a diffraction order of the diffracted light of m.

The present invention achieves the aforementioned object with flaw detection apparatus for detecting flaws in a pattern formed on a substrate, comprising an irradiating unit which irradiates the substrate with illuminating light; a light receiver which receives light of the illuminating light diffracted from the substrate; an image processor which subjects a pattern image due to diffracted light received at the light receiver to image processing so as to detect the flaws; changing unit which changes inspection conditions, for one set of at least two parameters of wavelength of the illuminating light, angle of incidence of the illuminating light, angle of diffraction of the diffracted light and diffraction order of the diffracted light, a plurality of times; wherein the image processor detects flaws based on the plurality of pattern images captured while the parameters are changed by the changing unit.

The changing unit changes at least two of the parameters θi, θd, m or λ so that the equation:

P×(sinθd−sinθi)=mλ

is satisfied for a pattern of pitch P, illuminating light of wavelength λ, an angle of incidence of the illuminating light of θi, an angle of diffraction of the diffracted light of θd, and a diffraction order of the diffracted light of m.

The illuminating light can be white light. The changing unit can be adjusting apparatus for supporting the substrate and tilting the substrate with respect to the illuminating light.

The present invention achieves the aforementioned object with a flaw detection apparatus for detecting flaws in a substrate surface, comprising: an illuminating unit which at least partially illuminates a substrate surface; an image-sensing unit which receives reflected light from at least part of the substrate surface, and generates an image signal according to reflectance of at least part of the substrate surface; a condition changing unit which arbitrarily changes conditions for generating the image signal generated by the image-sensing unit; and a detector which detects the presence of flaws at at least part of the surface of the substrate by comparing the plurality of image signals generated under the changed generating conditions.

The condition for generating the image signal is set by changing at least two of the parameters θi, θd m or λ in order that the equation:

P×(sinθd−sinθi)=mλ

is satisfied for a pattern of pitch P, illuminating light of wavelength λ, an angle of incidence of the illuminating light of θi, an angle of diffraction of the diffracted light of θd, and a diffraction order of the diffracted light of m.

### BRIEF DESCRIPTION OF THE DRAWINGS

FIG. 1 is a view showing the overall configuration of a flaw detection apparatus of a first embodiment according to the present invention.

FIG. 2 is a flowchart showing an operating procedure for a control part of the first embodiment of a flaw detection apparatus according to the the present invention.

FIG. 3 is a graph showing an amount of diffracted light received with respect to cross-sectional position of a silicon wafer of the first embodiment of a flaw detection apparatus according to the present invention.

FIG. 4 is a view showing the overall configuration of a flaw detection apparatus of a second embodiment according to the present invention.

FIG. 5 is a flowchart showing an operating procedure for a control part of the second embodiment of a flaw detection apparatus according to the present invention.

FIG. 6(a) is a cross-sectional view showing a resist pattern with no flaws, of fixed thickness on a silicon wafer, and FIG. 6(b) is a view showing an amount of diffracted light received with respect to cross-sectional position of the wafer in FIG. 6(a).

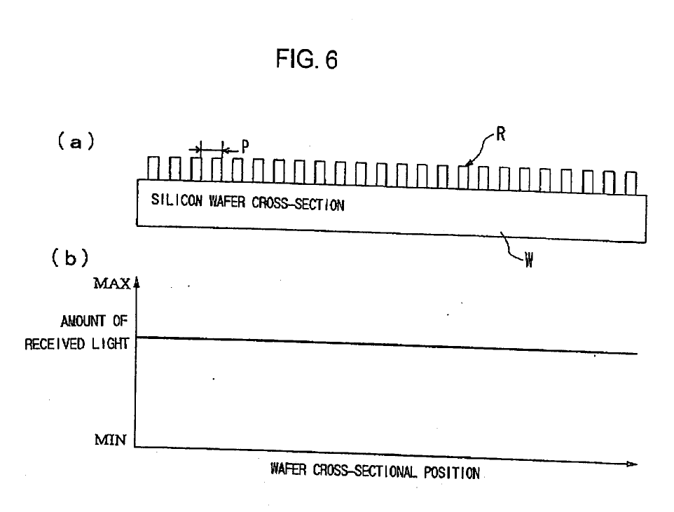

FIG. 7(a) is a cross-sectional view showing a resist pattern with a flaw, of fixed thickness on a silicon wafer, and FIG. 7(b) is a view showing an amount of diffracted light received with respect to cross-sectional position of the wafer in FIG. 7(a).

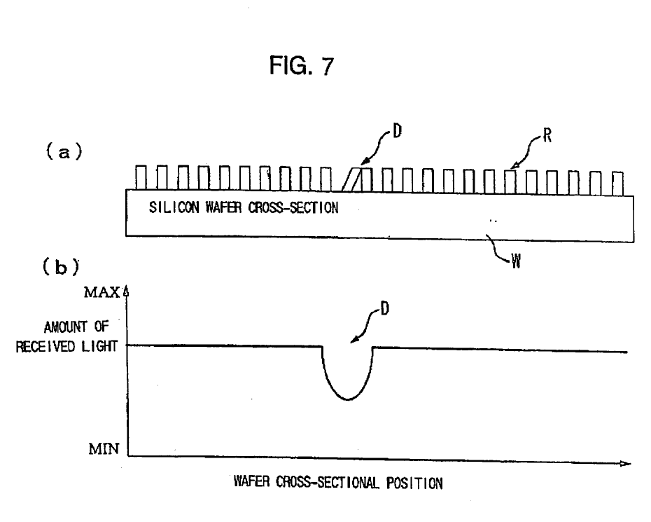

FIG. 8(a) is a cross-sectional view showing a resist pattern with no flaws but where thickness is not fixed, on a silicon wafer, and FIG. 8(b) is a view showing an amount of diffracted light received with respect to cross-sectional position of the wafer in FIG. 8(a).

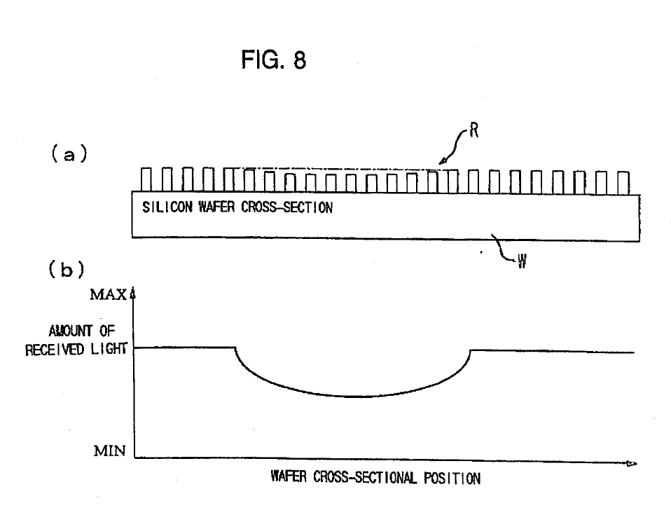

FIG. 9(a) is a cross-sectional view showing a resist pattern which has a flaw and is not of fixed thickness on a silicon wafer, and FIG. 9(b) is a view showing an amount of diffracted light received with respect to cross-sectional position of the wafer in FIG. 9(a).

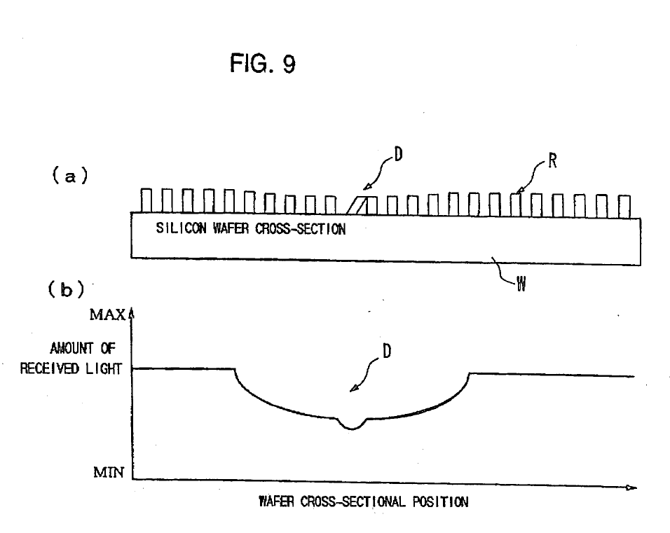

### DESCRIPTION OF THE PREFFERED EMBODIMENT

First Embodiment

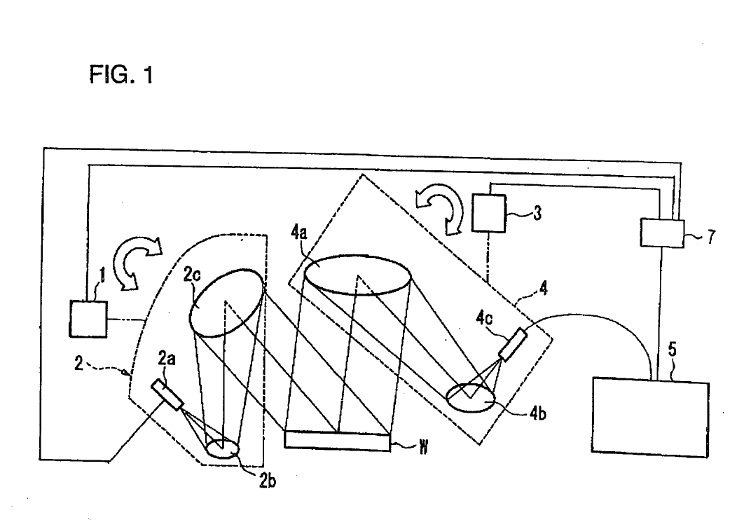

The following is a description with reference to FIG. 1 to FIG. 3 of a first embodiment of a flaw detection method and flaw detection apparatus according to the present invention.

As shown in FIG. 1, a flaw detection apparatus of this embodiment comprises a light-emitting-side drive system 1, an emitter 2, a light-receiving-side drive system 3, a light receiver 4, an image processor 5, and a controller 7. The flaw detection apparatus checks for flaws in a continuous pattern formed at a prescribed pitch P in a regular manner on a silicon wafer. In a process for forming a circuit pattern on the silicon wafer, a pattern image is projected onto the resist film, the pattern image is transferred to the surface of the silicon wafer by etching, and finally the resist is removed from the silicon wafer. The flaw detection apparatus detects flaws prior to the resist being removed.

The emitter 2 comprises a light source 2a constituted by a white light source, a light-emitting side reflector 2b for reflecting light emitted from the light source 2a, and a light-emitting side concave mirror 2c for making light emitted from the light-emitting side reflector 2b parallel and for irradiating the surface of a silicon wafer W constituting an inspection target with light. The light-emitting-side drive system 1 is a variable mechanism for tilting the emitter 2 and changes the angle of incidence of light illuminating the surface of the silicon wafer (substrate) W.

The light receiver 4 comprises a light-receiving-side concave mirror 4a for reflecting diffracted light from the silicon wafer W, a light receiving side reflector 4b for reflecting diffracted light from the light-receiving-side concave mirror 4a, and a CCD camera (image-sensing unit) 4c for receiving diffracted light from the light receiving side reflector 4b. The light-receiving-side drive system 3 is a variable mechanism for tilting the light receiver 4. The light receiver 4 is tilted in such a manner as to receive light, of light that is incident to the silicon wafer W at an angle of incidence of θi so as to be diffracted and reflected, that is diffracted light reflected at an angle of diffraction of θd satisfying equation (1) described later. This means that only a specific wavelength component of reflected light reaches the CCD camera 4c due to the light-receiving-side concave mirror 4a and light receiving side reflector 4b of the light receiver 4.

An image signal for the diffracted light received at the light receiver 4 is then sent to the image processor 5 and the image processor 5 checks for flaws in the following manner based on the inputted image signal.

The image processor 5 carries out image processing using a plurality of image signals for the diffracted light received at the CCD camera 4c and, for example, detects a maximum value in pixels and calculates an average value of pixels so as to detect the positions of flaws. The controller 7 comprises a CPU, ROM, RAM and peripheral circuitry and is connected to the light-emitting-side drive system 1, the emitter 2, the light-receiving-side drive system 3 and the image processor 5. An inspection process program described later is stored in the ROM of the controller 7 and the inspection process is executed in accordance with this program. The controller 7 sends instructions for various conditions such as wavelength of illuminating light, angle of incidence of illuminating light and diffraction angle of diffracted light etc. to each part according to the inspection process program.

In the first embodiment, the light-emitting-side drive system 1 and the light-receiving-side drive system 3 are reciprocally driven by the controller 7 so that the angle of incidence of the illuminating light with respect to the silicon wafer W and the diffraction angle of the diffracted light are decided so as to satisfy the following relationship.

Namely, taking the pitch of the pattern to be P, the wavelength of the illuminating light to be λ, the angle of incidence of the illuminating light to be θi, the angle of diffraction of the diffracted light to be θd, and the diffraction order of the diffracted light to be m, θi and θd are reciprocally varied in such a manner that:

P×(sinθd−sinθi)=mλ (1)

is satisfied.

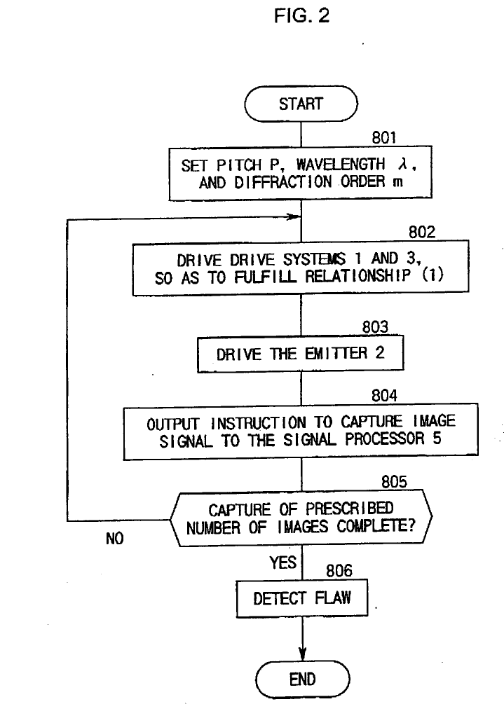

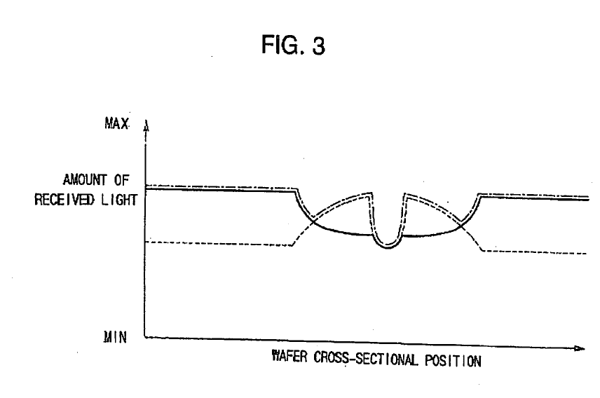

Next, a description is given with reference to FIG. 2 and FIG. 3 of a flaw detection method for a flaw detection apparatus of the first embodiment. FIG. 2 is a flowchart showing a process procedure for the inspection process program stored in the controller 7. FIG. 3 is a cross-sectional view showing a resist pattern of a silicon wafer of this embodiment and a view showing an amount of diffracted light received with respect to cross-sectional position of the wafer.

In step 801, the controller 7 sets the pitch P of the resist pattern on the silicon wafer, the wavelength λ of the illuminating light, and the diffraction order m, with these settings being inputted by an inspector using an input apparatus not shown. In step 802, the controller 7 sets inspection conditions taking the angle of incidence θi and the diffraction angle θd as a single set satisfying equation (1) and drives the light-emitting-side drive system 1 and the light-receiving-side drive system 3 to give these angles.

In step 803, the controller 7 causes the light source 2a to emmit white light therefrom. This white light is then irradiated onto the silicon wafer W as illuminating light at an angle of incidence θi satisfying the above conditions via the light-emitting side reflector 2b and the light-emitting side concave mirror 2c. This illuminating light is reflected from the silicon wafer W. At this time the illuminating light is diffracted by the resist pattern, and this diffracted light becomes incident to the CCD camera 4c via the light-receiving-side concave mirror 4a and the light receiving side reflector 4b. A pattern image received at the CCD camera 4c is converted to an image signal and outputted. In step 804, the controller 7 issues an instruction to capture the image signal to the image processor 5. The image processor 5 then captures the image signal sent from the CCD camera 4c and stores this image signal in a storage device not shown.

In step 805, the controller 7 determines whether or not a prescribed number R (≧2) has been acquired, i.e. a determination is made as to whether or not image signal capture is complete. When this is not the case, step 802 is returned to and step 802 to step 804 are repeatedly executed. One image signal is obtained from the CCD camera 4c under one set of inspection conditions of a specific angle of incidence θi and angle of diffraction θd.

When one set of inspection conditions is repeatedly changed up until the angle of incidence θi becomes (angle of incidence θi+X) and an image signal is captured, when the increment to the angle of incidence θi for one time is taken to be θ, the aforementioned prescribed number R can be expressed by X/θ, where X is set appropriately according to the thickness of the resist.

When step 802 is returned to from step 805, the light-emitting-side drive system 1 and the light-receiving-side drive system 3 are driven to give a specific combination of the angle of incidence θi and the angle of diffraction θd which is different from the combination up to that point, and step 803 and step 804 are repeated. In step 805, when a prescribed number of image signals R are captured, flaw detection processing is executed in step 806. At this time, image signals of R frames are stored in the storage device of the controller 7.

In step 806, the controller 7 subjects the R frames of captured image signals to image processing at the image processor 5 so as to process an image with little variation, and flaw detection is carried out.

Namely, image processing is carried out in which image signals for the plurality of stored patterns are compared for each pixel, so as to carriy out detection of maximum values and detection of average values etc. for the pixels, and then the positions of flaws are detected. For example, as shown by the solid lines and dotted lines in FIG. 3, at least two image signals (distribution of the amount of light received with respect to cross-sectional position of the wafer) are acquired. Image processing is then carried out so that just the maximum values for the signals shown by both the solid and dotted lines are extracted, and an inspection signal shown by a dotted-and-dashed line in FIG. 3 is generated. With this inspection signal, change in the amount of received light at the flaw is conspicuous and the position of this flaw can therefore be accurately specified.

Second Embodiment

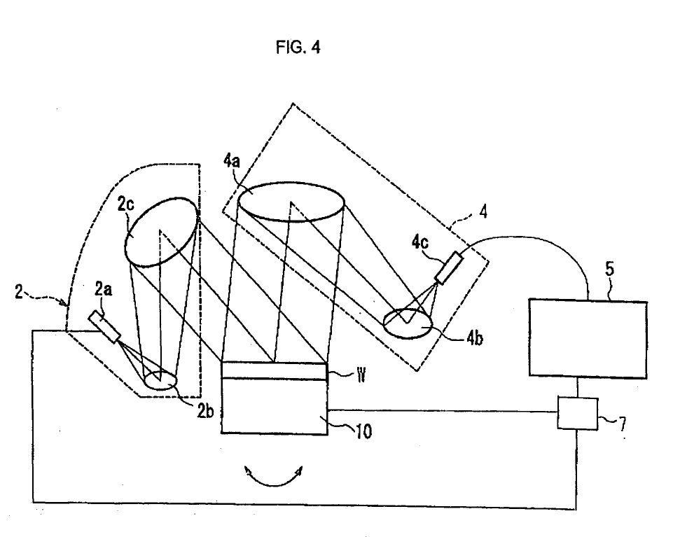

A second embodiment of a flaw detection apparatus of the present invention is now described with reference to FIG. 4.

In the second embodiment, rather than changing the angle of incidence θi and the angle of diffraction θd as in the first embodiment, the tilting angle of the silicon wafer W is changed so that the angle of incidence θi and the angle of diffraction θd substantially change.

As shown in FIG. 4, the flaw detection apparatus of the second embodiment comprise the emitter 2, the light receiver 4, a mounting table 10, the image processor 5 and the controller 7. Namely, the light-emitting-side drive system 1 and the light-receiving-side drive system 3 are omitted but the mounting table 10 for supporting the silicon wafer W and which can be vary the tilt angle to prescribed angles is provided. The mounting table 10 is tilted by an actuator (not shown) so as to tilt a silicon wafer W being supported. A tilting angle of the mounting table 10 is decided in such a manner that the angle of incidence θi of the illuminating light and the angle of diffraction θd of the diffracted light satisfy the relationship. By inclining the mounting table 10, white light irradiated from the emitter 2 and incident to the silicon wafer W at the angle of incidence θi is reflected as diffracted light of angle of diffraction θd from the silicon wafer W and just light of a specific wavelength is received by the light receiver 4.

In the second embodiment, a plurality of pattern images, i.e. a plurality of image signals, can be obtained under a plurality of different inspection conditions satisfying the relationship in the same manner as for the first embodiment just by driving the mounting table 10. Flaws can therefore be easily detected using the same image processing as for the first embodiment.

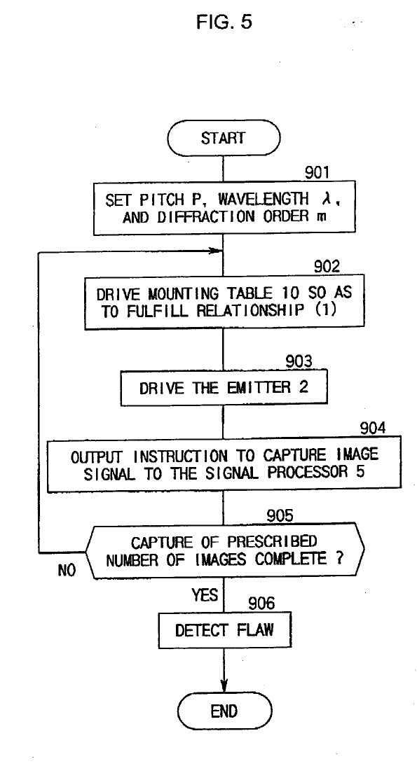

In the following, a description is given with reference to FIG. 5 of a flaw detection method for a flaw detection apparatus of the second embodiment. FIG. 5 is a flowchart showing a processing procedure for the controller 7 of the second embodiment.

In step 901, the controller 7 sets the pitch P of the resist pattern on the silicon wafer, the wavelength λ of the illuminating light, and the diffraction order m. In step 902, the controller 7 controls the actuator of the mounting table 10 so as to change the tilting angle of the mounting table 10 in order to change the angle of incidence θi and the angle of diffraction θd so that these angles satisfy equation (1).

In step 903, the controller 7 causes the light source 2a to emmit white light therefrom. This white light is then irradiated onto the silicon wafer W as illuminating light at an angle of incidence θi satisfying the above conditions via the light-emitting side reflector 2b and the light-emitting side concave mirror 2c. This illuminating light is reflected from the silicon wafer W. At this time the illuminating light is diffracted by the resist pattern at a angle of diffraction θd for the aforementioned conditions, and this diffracted light becomes incident to the CCD camera 4c via the light-receiving-side concave mirror 4a and the light receiving side reflector 4b. A pattern image received at the CCD camera 4c is converted to an image signal and outputted. In step 904, the controller 7 issues an instruction to capture the image signal to the image processor 5. The image processor 5 then captures the image signal sent from the CCD camera 4c and stores this image signal in a storage device (not shown).

In step 905, the controller 7 repeats step 902 to step 904 until it is determined that the prescribed number R (≧2) of image signals is acquired. When step 902 is returned to from step 905, the controller 7 drives the actuator of the mounting table 10 in such a manner as to change the tilt angle of the mounting table 10. One image signal is obtained for each specific tilt angle of the mounting table 10. The tilt angle is equivalent to obtaining specific combinations of the angle of incidence θi and the angle of diffraction θd . In step 906, the controller 7 carries out flaw detection in the same manner as for the first embodiment.

In each of the above embodiments, single sets of parameters for the angle of incidence θi and the angle of diffraction θd satisfying equation (1) are taken as conditions for generating each image signal. The generating conditions are then changed and a plurality of image signals obtained in this manner are compared so as to detect flaws on the silicon wafer W.

In each of the above embodiments, an amount of light received for the reflected diffracted light diffracted for the pattern image is detected and image processing of this image signal according to this amount of received light is carried out. However, when the diffracted light is part of the reflected light, the CCD camera receives the reflected light and generates an image signal according to the reflectance.

The present invention can also be modified in the following manner.

(1) In each of the above embodiments, one set of the angle of incidence θi and the angle of diffraction θd are changed in order to satisfy equation (1). However, a plurality of pattern images can be received by taking at least two or more of the parameters (θi, θd, λ, m) of equation (1) as one set and changing the parameters for each set. It is also acceptable that detection is carried out using other combinations of parameters. For example, the wavelength λ and another parameter can be changed to satisfy equation (1). In this case, white light from a white light source can be passed through a band pass filter so that light having a specific wavelength can be extracted. Changing the pass band of the band pass filter may change the wavelength of the illuminating light.

(2) In each of the above embodiments, the whole of the surface of the silicon wafer W is irradiated with illuminating light so as to carry out flaw detection. But it is also possible to just irradiate part of the surface with illuminating light. Flaws occurring in prescribed regions set beforehand can then be rapidly detected because in this case image processing can be completed for just one portion.

(3) In each of the above embodiments, a silicon wafer W is taken as a substrate to be inspected but other substrates may also be subjected to inspection. For example, flaws in a circuit pattern formed on the surface of a silicon glass substrate can also be detected.

The embodiments described above bring about the following advantage.

According to the first and second embodiments, by changing inspection conditions, obtaining a plurality of patterns where the difference between an amount of light for a flaw and an amount of light for another portion changes, and subjecting this plurality of pattern images to image processing, flaws can be accurately detected without being unduly influenced by inconsistencies in diffracted images occurring due to variations in resist thickness and height of foundation layer.

According to the second embodiment, by providing a mounting table for supporting the substrate and tilting the substrate with respect to illuminating light, the angle of incidence and the angle of diffraction can be simultaneously changed just by changing the inclination of the substrate using the mounting table and flaw deflection can be carried out in a straightforward manner.

What is claimed is:

1. A method for detecting flaws in a specified pattern formed on a substrate, comprising the steps of:
irradiating the substrate with illuminating light;
receiving light of the illuminating light diffracted from the specified pattern on the substrate;
setting different inspection conditions, for one set of at least two parameters of wavelength of the illuminating light, angle of incidence of the illuminating light, angle of diffraction of the diffracted light from the specified pattern and diffraction order of the diffracted light from the specified pattern, a plurality of times; and
detecting the flaws based on a plurality of pattern images due to the diffracted light from the specified pattern, the plurality of pattern images being obtained according to the plurality of inspection conditions set in said setting step.

2. The flaw detection method of claim 1, wherein in said flaw detecting step, at least two of the parameters θi, θd, m or λ are changed in order that the equation:
P×(sinθd−sinθi)=mλ
is satisfied for the specified pattern of pitch P, illuminating light of wavelength λ, an angle of incidence of the illuminating light of θi, an angle of diffraction of the diffracted light of θd, and a diffraction order of the diffracted light of m.

3. A flaw detection apparatus for detecting flaws in a specified pattern formed on a substrate, comprising:
an irradiating unit which irradiates the substrate with illuminating light;
a light receiver which receives light of the illuminating light diffracted from the specified pattern on the substrate;
an image processor which subjects a pattern image due to diffracted light received at the light receiver to image processing so as to detect the flaws; and
a changing unit which changes inspection conditions, for one set of at least two parameters of wavelength of the illuminating light, angle of incidence of the illuminating light, angle of diffraction of the diffracted light from the specified pattern, and diffraction order of the diffracted light from the specified pattern, wherein
said image processor detects flaws based on the plurality of pattern images captured while changing parameters by said changing unit, the plurality of pattern images being obtained from the specified pattern.

4. The flaw detection apparatus of claim 3, wherein said changing unit changes at least two of the parameters θi, θd, m or λ in order that the equation:
P×(sinθd−sinθi)=mλ
is satisfied for the specified pattern of pitch P, illuminating light of wavelength λ, an angle of incidence of the illuminating light of θi, an angle of diffraction of the diffracted light of θd, and a diffraction order of the diffracted light of m.

5. The flaw detection apparatus of claim 3, wherein the illuminating light is white light.

6. The flaw detection apparatus of claim 3, wherein said changing unit is equipped with adjusting apparatus for supporting the substrate and tilting the substrate with respect to the illuminating light.

7. The flaw detection method of claim 2, wherein one set of inspection condition parameters is the angle of incidence θi of the illuminating light incident to the substrate and the angle of diffraction θd of diffracted light diffracted and reflected at the substrate.

8. The flaw detection apparatus of claim 4, wherein one set of inspection condition parameters is the angle of incidence θi of the illuminating light incident to the substrate and the angle of diffraction θd of diffracted light diffracted and reflected at the substrate.

9. The flaw detection method of claim 1, wherein the plurality of pattern images are detected by a single light receiver.

10. The flaw detection apparatus of claim 3, wherein the light receiver is a single light receiver.

11. The flaw detection method of claim 1, wherein:
one set of inspection condition parameter is the angle of the illumination light incident to the substrate and the angle of diffraction light diffracted at the substrate.
